(19) United States
(12) Patent Application Publication
(10) Pub. No.: US 2026/0017767 A1
(43) Pub. Date: Jan. 15, 2026

(54) RAILROAD ASSET MONITORING BASED ON COMPACT ASSET DATA

(71) Applicant: Caterpillar Inc., Peoria, IL (US)

(72) Inventors: Lawrence A. Mianzo, Pittsburgh, PA (US); Tod A. Oblak, Pittsburgh, PA (US); Michael Hoffelder, Norwich, NY (US); Marc D. Miller, Lee's Summit, MO (US)

(73) Assignee: Caterpillar Inc., Peoria, IL (US)

(21) Appl. No.: 18/773,290

(22) Filed: Jul. 15, 2024

(51) Int. Cl. G06T 7/00; B61K 9/08; G06T 7/73; G06V 10/764; G06V 20/56

(52) U.S. Cl. CPC G06T 7/0002; B61K 9/08; G06T 7/74; G06V 10/764; G06V 20/56; G06T 2207/20081; G06T 2207/30184; G06T 2207/30232; G06T 2207/30252

(57) ABSTRACT

A camera on a railroad vehicle captures image data depicting a surrounding environment. An on-board computing system of the railroad vehicle uses image processing operations to identify railroad assets and/or railroad asset subcomponents depicted in the image data. The on-board computing system may evaluate the image data to identify, substantially in real time, defects in the railroad assets and/or subcomponents depicted in the image data. The on-board computing system may also, or alternately, generate compact asset data, such as vectors, splines, and/or polygons, that represents the types, shapes, orientations, and locations of railroad assets and/or subcomponents identified based on the captured image data. Comparison of compact asset data associated with different points in time may identify changes to the shapes, orientations, and locations of the railroad assets and/or subcomponents over time that may be indicative of defects.

### TECHNICAL FIELD

The present disclosure relates to monitoring railroad assets and, more particularly, to detecting defects in railroad assets based on image data captured by locomotive cameras.

### BACKGROUND

Railroad vehicles, such as trains including locomotives, railroad cars, and/or other elements, may travel along rails of a railroad. The railroad may also be associated with other types of infrastructure, such as switches, crossings, signals, bridges, and/or other types of elements that may be at or near the rails of the railroad.

Rails and/or other railroad infrastructure elements may deteriorate or otherwise change over time due to wear and tear, weather conditions, defects, and/or other issues. Accordingly, it may be useful to monitor the condition of railroad infrastructure elements over time, for instance so that changes to railroad infrastructure elements that may pose safety risks and/or indicate other issues may be identified and addressed.

Various systems have been developed in the past to detect and/or identify railroad infrastructure elements. For example, U.S. Pat. No. 9,796,400 to Puttagunta et al. (hereinafter “Puttagunta”) describes a system in which a machine vision system, such as a LiDAR sensor, may be mounted on a train in order to generate point-cloud data about rails and other objects present in a local environment around the train. However, while the system described by Puttagunta may use point-cloud data about the train's environment for real-time navigation and control of the train and other real-time analyses, the system described by Puttagunta may have limited abilities to monitor railroad infrastructure elements for changes over a period of time.

Examples of the present disclosure are directed to overcoming the deficiencies noted above.

### SUMMARY

According to a first aspect of the present disclosure, a method is executed by a computing system including a processor. The method includes obtaining image data captured by a camera on-board a railroad vehicle at a first time. The method includes identifying a railroad asset depicted in the image data. The method includes generating first compact asset data representing a shape and a location of the railroad asset at the first time. The method includes comparing the first compact asset data with second compact asset data that represents the shape and the location of the railroad asset at a second time. The method includes determining, based on comparing the first compact asset data with the second compact asset data, that at least one of the shape or the location of the railroad asset has changed over a period of time between the first time and the second time.

According to a second aspect of the present disclosure, a railroad asset monitoring system includes: a camera on a railroad vehicle and an on-board computing system on the railroad vehicle. The camera is configured to capture image data depicting an environment that is at least partially in front of the railroad vehicle. The on-board computing system is configured to perform operations. The operations include obtaining the image data captured by the camera at a first time. The operations include identifying a railroad asset depicted in the image data. The operations include generating first compact asset data representing a shape and a location of the railroad asset at the first time. The operations include comparing the first compact asset data with second compact asset data that represents the shape and the location of the railroad asset at a second time. The operations include determining, based on comparing the first compact asset data with the second compact asset data, that at least one of the shape or the location of the railroad asset has changed over a period of time between the first time and the second time.

According to a third aspect of the present disclosure, a computing system includes one or more processors and memory. The memory stores computer-executable instructions that, when executed by the one or more processors, cause the one or more processors to perform operations. The operations include identifying first compact asset data representing a shape and a location of a railroad asset at a first time. The operations include identifying second compact asset data representing the shape and the location of the railroad asset at a second time. The operations include determining, based on comparing the first compact asset data with the second compact asset data, that at least one of the shape or the location of the railroad asset has changed over a period of time between the first time and the second time. The first compact asset data and the second compact asset data respectively use at least one of a polygon, a vector, or a spline to define the shape and the location of the railroad asset.

According to a fourth aspect of the present disclosure, a method is executed by a computing system, including a processor, on-board a railroad vehicle. The method includes obtaining image data captured by a camera on-board the railroad vehicle. The method includes identifying, by analyzing the image data, a first classification of a railroad asset depicted in the image data. The railroad asset is an infrastructure element that comprises multiple subcomponents. The method includes identifying, by analyzing the image data, a second classification of a subcomponent of the railroad asset. The method includes determining, by using computer vision operations to evaluate the image data based on the second classification, that the image data depicts a defect with the subcomponent of the railroad asset.

### BRIEF DESCRIPTION OF THE DRAWINGS

The detailed description is described with reference to the accompanying figures. In the figures, the left-most digit of a reference number identifies the figure in which the reference number first appears. The same reference numbers in different figures indicate similar or identical items.

FIG. 1 shows an example of a railroad asset monitoring system in which an on-board computing system, carried by a railroad vehicle traveling on rails of a railroad, may monitor railroad assets and/or may detect defects in the railroad assets.

FIG. 2 shows an example of rail data that indicates, as compact asset data, shapes and locations of rails depicted in image data captured by a camera on the railroad vehicle.

FIG. 3 shows an example of other asset data that indicates, as compact asset data, shapes and locations of subcomponents of a railroad switch that are depicted in image data captured by a camera on the railroad vehicle.

FIG. 4 is a flowchart illustrating an example process for using image data captured by the camera to detect defects with railroad assets and/or subcomponents of railroad assets substantially in real-time.

FIG. 5 is a flowchart illustrating an example process for using image data captured by the camera to generate compact asset data indicative of types, shapes, and/or locations of railroad assets and/or subcomponents of railroad assets depicted in the image data.

FIG. 6 is a flowchart illustrating an example process for using compact asset data to identify changes, over a period of time, to railroad assets that may be indicative defects or other issues with the railroad assets.

FIG. 7 shows an example system architecture for a computing system that executes one or more elements described in the present disclosure.

### DETAILED DESCRIPTION

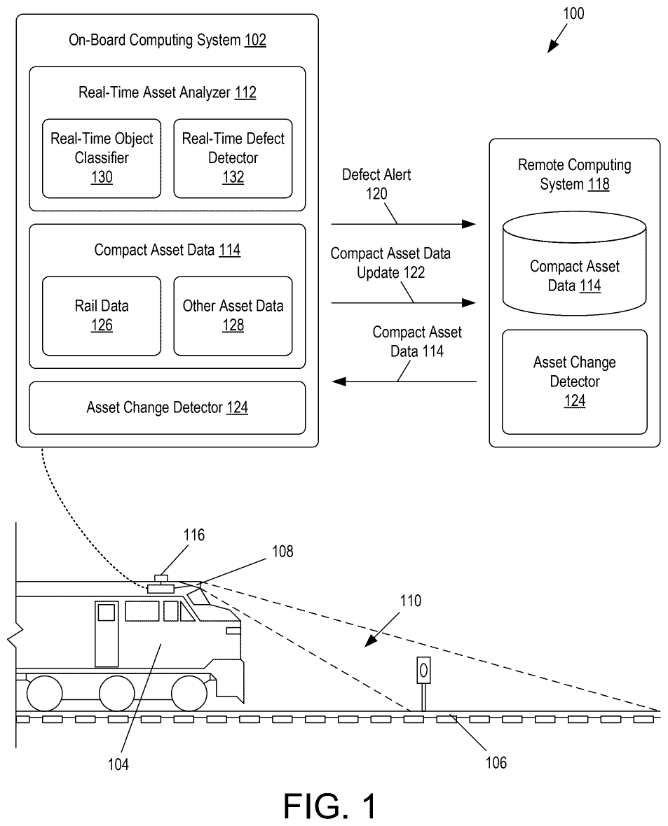

FIG. 1 shows an example of a railroad asset monitoring system 100 in which an on-board computing system 102, carried by a railroad vehicle 104 traveling on rails of a railroad, may monitor railroad assets 106 and/or may detect defects in the railroad assets 106. In some examples, the railroad vehicle 104 may be a train, such as a train including a locomotive, one or more railroad cars, and/or other elements. In other examples, railroad vehicle 104 may be a single locomotive or other rail vehicle that is configured to travel along rails of a railroad.

The railroad assets 106 may include rails of railroad tracks, such as rails that wheels of the railroad vehicle 104 may interact with while traveling along the railroad tracks. The railroad assets 106 may also, or alternately, include other types of railroad infrastructure elements, such as switches, crossings, signals, bridges, and/or other types of elements that may support rails, may interact with rails, or may otherwise be present near rails at or along portions of railroad tracks.

A camera 108 on-board the railroad vehicle 104 may capture image data depicting railroad assets 106, such as railroad assets 106 that are present in an environment in front of and/or around the railroad vehicle 104 within a field of view 110 of the camera 108. The on-board computing system 102 may use a real-time asset analyzer 112 to locally process image data captured by the camera 108, for instance to detect and/or classify types of railroad assets 106 shown in the image data, and/or to determine whether the image data indicates any immediate defects with detected railroad assets 106. The on-board computing system 102 may also use local detection and/or classification of railroad assets 106 shown in the image data, by the real-time asset analyzer 112, to generate new or updated compact asset data 114. The compact asset data 114 may indicate information about railroad assets 106, such as types of railroad assets 106, shapes of railroad assets 106, and/or locations of railroad assets 106. The on-board computing system 102 may also, in some examples, compare the new or updated compact asset data 114 against previous compact asset data 114, in order to detect changes to railroad assets 106 over periods of time that may be indicative of defects or other issues.

The camera 108 may be mounted and/or positioned on the railroad vehicle 104 such that the field of view 110 of the camera 108 is at least partially in front of the railroad vehicle 104. For example, if the railroad vehicle 104 is a train with a locomotive at the front as shown in FIG. 1, the camera 108 may be mounted on the locomotive at a position proximate to the front of the locomotive so that the field of view 110 is at least partially ahead of the locomotive as the locomotive travels forward along railroad tracks. If a locomotive is not at the front of the train, the camera 108 may be similarly mounted on a leading railroad car of the train such that the field of view 110 is at least partially ahead of the train as the train travels forward along railroad tracks.

In some examples, the camera 108 may be mounted on an exterior of the railroad vehicle 104. In other examples, the camera 108 may be positioned within an interior of the railroad vehicle 104, but be configured or positioned such that camera 108 may capture image data associated with the field of view 110 through a window or opening.

In some examples, the field of view 110 of the camera 108 may be oriented such that captured image data may depict a portion of the front end of the railroad vehicle 104. However, the field of view 110 of the camera 108 may be oriented such that captured image data also, or fully, depicts elements in an environment in front of and/or around the railroad vehicle 104 as shown in FIG. 1.

The camera 108 may have one or more image sensors that are configured to capture image data, such as still images, video frames, or other types of image data. As an example, the camera 108 may have two image sensors configured to capture stereoscopic images of the field of view 110, such that the on-board computing system 102 may use stereoscopic image data to identify locations of railroad assets 106 in three-dimensional space.

Image data captured by the camera 108 may include color images, grayscale images, and/or other types of images. In some examples, the camera 108 may be configured to capture image data based on the visible light spectrum. For instance, the camera 108 may be configured capture color images of railroad assets 106 during daylight hours, and/or when railroad assets 106 are illuminated by headlights of a locomotive and/or other light sources. In other examples, the camera 108 may be configured to capture image data based on the infrared spectrum, the ultraviolet spectrum, and/or other spectrum ranges, such that railroad assets 106 may be depicted by such image data when the image data is captured at night, and/or regardless of whether the railroad assets 106 are illuminated when the image data is captured.

In some examples, the camera 108 and/or the railroad vehicle 104 may have other types of sensors that may measure and/or capture information about the railroad vehicle 104 and/or railroad assets 106 in front of, and/or around, the railroad vehicle 104. As an example, the railroad vehicle 104 may have LiDAR (Light Detection and Ranging) sensors, radar sensors, or other types of sensors that may provide the on-board computing system 102 with sensor data indicative of the presence and/or location of one or more types of railroad assets 106 within an environment in front of and/or around the railroad vehicle 104.

As another example, the camera 108 and/or the railroad vehicle 104 may have Global Positioning System (GPS) sensors, sensors configured to detect the orientation and/or heading of the railroad vehicle 104, and/or other types of location and/or positional sensors. Such sensors may determine geographic location information, heading information, and/or other location or positional data associated with the camera 108 and/or the railroad vehicle 104. For instance, sensor data captured by such sensors may be used to track movements of the railroad vehicle 104 over time, to determine where the camera 108 and/or the railroad vehicle 104 was located when corresponding image data was captured by the camera 108, determine an orientation or heading of the railroad vehicle 104 at a time when an instance of image data was captured by the camera 108, and/or other types of information.

Such location information may accordingly be used determine and/or indicate geographic locations of railroad assets 106 that are depicted in captured image data and/or are defined by corresponding compact asset data 114. As a non-limiting example, GPS data may indicate that, at a particular time at which the camera 108 captured a particular image, the railroad vehicle 104 was located at a geographical location that is proximate to two parallel sets of railroad tracks. A history of GPS data and/or other heading or orientation data may indicate that, at the particular time, the railroad vehicle 104 was traveling in a northbound direction. Accordingly, based on such information, it may be determined that the captured image depicts railroad assets 106 along one of the two sets of parallel sets of railroad tracks that is associated with northbound travel, and/or otherwise allow different railroad assets 106 associated with the different sets of railroad tracks to be identified and/or distinguished within the image. Similarly, identification of particular railroad assets 106, such as switches, crossings, signals, bridges, and/or other types of elements, within captured image data and/or within compact asset data 114 may be used to identify locations and/or travel directions associated with the railroad vehicle 104 at different points of time. For instance, if image data captured at or near particular GPS coordinates depicts railroad switches, and previously-determined compact asset data 114 or other predetermined information indicates the presence of railroad switches at or near those GPS coordinates in association with a first set of railroad tracks instead of a nearby second set of railroad tracks, it may be determined that the image data and any depicted railroad assets 106 are associated with the first set of railroad tracks.

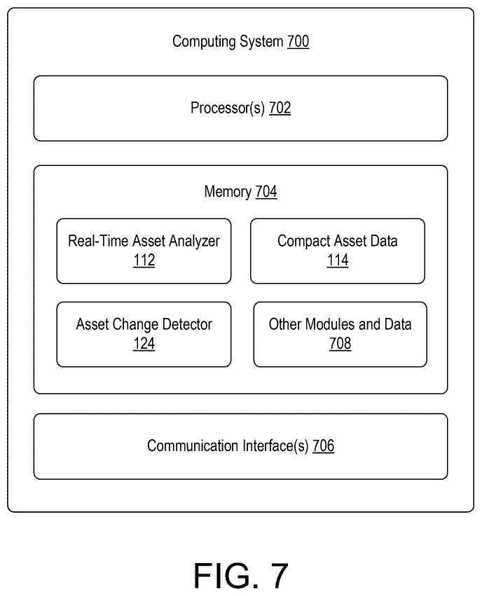

The on-board computing system 102 may be located on-board the railroad vehicle 104. For example, if the railroad vehicle 104 is a train, the on-board computing system 102 may be on-board a locomotive, a railroad car, or other portion of the train. The on-board computing system 102 may accordingly travel with the railroad vehicle 104. In some examples, the on-board computing system 102 may be a component of the camera 108, such as a system-on-a-chip within a housing of the camera 108. In other examples, the on-board computing system 102 may be a separate computer or computing device that is connected to the camera 108 or that may otherwise receive image data and/or other data via wired and/or wireless data connections. FIG. 7, discussed further below, describes an example system architecture for the on-board computing system 102.

The on-board computing system 102 may use one or more communication interfaces 116 of the on-board computing system 102, the railroad vehicle 104, and/or other elements to send data to, and/or receive data from, a remote computing system 118 that is separate from the on-board computing system 102 and the railroad vehicle 104. For example, the on-board computing system 102 and/or the railroad vehicle 104 may have cellular data interfaces, satellite data interfaces, and/or other types of communication interfaces that may allow the on-board computing system 102 to communicate wirelessly with the remote computing system 118.

The remote computing system 118 may be a server or other computing system that executes in a cloud computing environment, at a back office, and/or at another location that may be separate and/or remote from the location of the railroad vehicle 104. FIG. 7, discussed further below, describes an example system architecture for the remote computing system 118.

The remote computing system 118 may store and/or maintain a database of compact asset data 114. As discussed above, the on-board computing system 102 may also use compact asset data 114. In some examples, the on-board computing system 102 may receive compact asset data 114 from the remote computing system 118 via one or more communication interfaces 116, for instance via a cellular data connection, satellite data connection, or other wireless data connection. The on-board computing system 102 may store the compact asset data 114, received from the remote computing system 118, in local memory of the on-board computing system 102.

Accordingly, in some examples or situations the on-board computing system 102 may use a local copy of compact asset data 114 previously received from the remote computing system 118, without engaging in real-time communications with the remote computing system 118. For instance, if the railroad vehicle 104 is located in a remote environment that does not have cellular service, such that the on-board computing system 102 may be unable to communicate with the remote computing system 118 via a communication interface 116, the on-board computing system 102 may use a local copy of compact asset data 114 that was previously received from the remote computing system 118.

As described further below, the on-board computing system 102 may, by using the real-time asset analyzer 112 and/or the compact asset data 114, detect a defect in a railroad asset 106. If the on-board computing system 102 detects such a defect in a railroad asset 106, the on-board computing system 102 may use a communication interface 116 to transmit a corresponding defect alert 120 to the remote computing system 118. The remote computing system 118 may, in response to the defect alert 120, be configured to dispatch one or more workers to investigate and/or fix the defect in the railroad asset 106, or to notify one or more users or entities who may dispatch such workers to investigate and/or fix the defect in the railroad asset 106.

In some examples, the on-board computing system 102 may also, or alternately, generate new or updated compact asset data 114 based on a local analysis of image data captured by the camera 108, as described further below. The on-board computing system 102 may accordingly transmit a corresponding compact asset data update 122 to the remote computing system 118 via a communication interface 116, such that the remote computing system 118 may update the compact asset data 114 stored at the remote computing system 118 based on the compact asset data update 122 provided by the on-board computing system 102.

As described herein, the on-board computing system 102 may use the real-time asset analyzer 112 to detect defects in railroad assets 106. For instance, the real-time asset analyzer 112 may detect a buckle in a rail based on a real-time analysis of image data captured by the camera 108.

However, the on-board computing system 102 may also, or alternately, be configured to locally use an asset change detector 124 to detect defects in railroad assets 106 based on comparisons of one or more pre-existing versions of the compact asset data 114 against new or updated compact asset data 114 generated based on a local analysis of image data captured by the camera 108. Accordingly, while the real-time asset analyzer 112 may use image data associated with a single point in time to detect defects in railroad assets 106, the asset change detector 124 may use comparisons of compact asset data 114 associated with different points in time to detect changes in railroad assets 106 that may have occurred over a longer period of time.

As discussed above, in some examples the on-board computing system 102 may be configured to send a compact asset data update 122 to the remote computing system 118 based on new compact asset data 114 generated by the on-board computing system 102, and the remote computing system 118 may use the compact asset data update 122 to update the database of compact asset data 114 maintained at the remote computing system 118. In these examples, the remote computing system 118 may execute an instance of the asset change detector 124 to detect changes in railroad assets 106 that may have occurred over a period of time. For instance, the remote computing system 118 may use the asset change detector 124 to detect defects in railroad assets 106 by comparing one or more historical versions of the compact asset data 114 against compact asset data 114 that has been updated based on the compact asset data update 122 received from the on-board computing system 102.

The compact asset data 114 used by the on-board computing system 102 and/or the remote computing system 118 may be data that represents types and locations of railroad assets 106, and/or types and locations of individual subcomponents the railroad assets 106. The compact asset data 114 may include rail data 126 and other asset data 128. The rail data 126 may use vectors, splines, and/or other types of data to identify coordinates, in three-dimensional space, of locations of points along rails. The other asset data 128 may use polygons to represent shapes of switches, crossings, signals, bridges, and/or other types of railroad infrastructure elements different from rails. The other asset data 128 may also identify coordinates, in three-dimensional space, of vertices of the polygons to indicate locations and/or spatial orientations of the railroad infrastructure elements represented by the polygons, and/or otherwise identify locations of the railroad infrastructure elements represented by the polygons.

In some examples, the rail data 126 and/or the other asset data 128 may represent shapes and locations of individual subcomponents of one or more types of railroad infrastructure elements. For instance, if a particular railroad infrastructure element is a mechanical element or a relatively large element that includes multiple subcomponents that may be individually detected and/or monitored, corresponding rail data 126 and/or corresponding other asset data 128 may identify the types and/or locations of the individual subcomponents.

As a first example, a railroad switch may include multiple subcomponents, such as closure rails, guard rails, and a frog that guides train wheels onto particular rails according to a configuration of the switch. Accordingly, the rail data 126 may include vectors, splines, and/or other data indicating locations of one or more types of rails within a switch, while the other asset data 128 may include a polygonal representation of a frog within the switch and/or other non-rail subcomponents of the switch.

As a second example, a railroad crossing may be associated with rails that cross a roadway. Accordingly, in this example the rail data 126 may include vectors, splines, and/or other data indicating locations of one or more types of rails within a crossing, while the other asset data 128 may include a polygonal representation of the roadway that crosses the rails.

As a third example, a railroad bridge may include multiple subcomponents, such as bridge rails, a bridge interface, a bridge deck, railings or fences extending along edges of the bridge deck, and/or other elements. Accordingly, the rail data 126 may include vectors, splines, and/or other data indicating locations of one or more types of rails that extend along a length of the bridge, while the other asset data 128 may include polygonal representations of the bridge deck, bridge railings or fences, and/or other elements of the bridge.

The vectors, splines, polygons, and/or other types of data used in the compact asset data 114 to represent the types and/or locations of railroad assets 106 may cause the compact asset data 114 to be smaller in size than other types of data that could potentially represent the types and/or locations of railroad assets 106. Accordingly, the relatively small size of the compact asset data 114 may allow the compact asset data 114 to be stored in local memory at the on-board computing system 102 more efficiently than other types of data. Similarly, the relatively small size of the compact asset data 114 may allow the compact asset data 114 to be transferred via a wireless data connection from the remote computing system 118 to the on-board computing system 102 more quickly and/or efficiently than other types of data.

As an example, the vectors and/or splines used in the rail data 126 may represent shapes and locations of relatively long sections of rails using relatively few coordinates and/or a relatively small amount of data. For instance, if a one hundred foot section of a rail is straight, the rail data 126 may include data defining a single vector that represents the entire one hundred foot section of the rail, such as data identifying coordinates of two endpoints of the vector in three-dimensional space. Similarly, if a relatively lengthy section of rail has a smooth curved shape, the rail data 126 may include a polynomial function or other data defining a single spline that indicates the curved shape of that entire section of rail, and/or one or more coordinates that indicate the location of the curved section of rail in three-dimensional space. Accordingly, rather than storing a large number of coordinates of a large number of points that are located every few inches or every few feet along a rail, the rail data 126 may use a smaller number of coordinates in association with corresponding vectors and/or splines to indicate the shapes and positions of long sections of the rail.

As another example, the polygonal representations used in the other asset data 128 may also represent shapes and locations of instances of other types of railroad assets 106 using relatively few coordinates and/or a relatively small amount of data. For instance, if a bridge fence is rectangular, the other asset data 128 may include data defining coordinates, in three-dimensional space, of four corner points of a rectangle that represents the shape and location of the bridge fence. Accordingly, rather than storing a point cloud representation indicating positions of hundreds or thousands of points on the bridge fence, or storing a full digital image of the bridge fence, the other asset data 128 may use a relatively small number of coordinates to define a polygon that represents the shape and/or spatial orientation of the bridge fence.

The compact asset data 114 may in some examples be generated and/or updated based on detection, by the real-time asset analyzer 112 executed by the on-board computing system 102, of railroad assets 106 depicted in image data captured by the camera 108. As described herein, the real-time asset analyzer 112 may be configured to analyze image data captured by the camera 108 to detect, substantially in real-time, objects depicted in the image data. The real-time asset analyzer 112 may use detection of such objects to detect defects in railroad assets 106 in real-time, for instance if a real-time analysis of image data captured at a single point in time indicates that the current shape and/or current location of a detected railroad asset 106 is indicative of a defect or safety risk.

However, the detection of objects shown in captured image data by the real-time asset analyzer 112 may also be used to generate new or updated compact asset data 114 that indicates detected shapes and/or locations of detected objects. The on-board computing system 102 and/or the remote computing system 118 may then use such new or updated compact asset data 114 to compare the newly-determined shapes and/or locations of objects against previously-determined shapes and/or locations of those objects indicated by previous compact asset data 114, in order to determine if the shapes and/or locations of those objects have changed over time. Accordingly, while the real-time asset analyzer 112 may use image data associated with a single point in time to detect defects in railroad assets 106, the asset change detector 124 may use comparisons of compact asset data 114 associated with different points in time to detect changes in railroad assets 106 that may have occurred over a longer period of time and that may be indicative of defects.

As a non-limiting example, if ground conditions, weather conditions, or other issues cause a section of rail to drift and slowly move over a period of weeks or months, the real-time asset analyzer 112 might not detect any rail buckling or other immediate defects or safety issues associated with the section of rail based on a real-time analysis of image data captured at a single point in time. However, the asset change detector 124 may detect the slow movement of the section of rail over the relatively long period of time by comparing new or updated compact asset data 114 that indicates the current shape and/or location of the section of rail against historical compact asset data 114 that indicates one or more previous shapes and/or locations of the same section of rail.

The real-time asset analyzer 112 executed by the on-board computing system 102 may use image processing systems, such as a real-time object classifier 130 and/or a real-time defect detector 132, to process image data captured by the camera 108. The image processing systems executed by the on-board computing system 102 may, in some examples, use machine learning techniques, artificial intelligence techniques, computer vision techniques, and/or other techniques to evaluate and interpret image data captured by the camera 108. For instance, the real-time asset analyzer 112 may use image processing techniques, machine learning techniques, computer vision techniques, and/or other techniques discussed in U.S. Pat. No. 11,834,082 and U.S. patent application Ser. No. 18/589,446, which are incorporated herein by reference, to identify rails depicted in image data captured by the camera 108 and/or to detect buckling or other defects with identified rails. However, as described herein, the real-time asset analyzer 112 may also use the same or similar techniques to identify other types of railroad assets 106 and/or railroad asset subcomponents depicted in image data captured by the camera 108, and/or to detect defects with the identified railroad assets 106 and/or railroad asset subcomponents.

For example, the real-time object classifier 130 may use machine learning techniques, such as deep learning techniques, to detect and classify railroad assets 106 depicted in captured image data. The real-time object classifier 130 may also use machine learning systems, such as deep learning techniques, to detect and classify subcomponents of the railroad assets 106 depicted in captured image data. Based on detection and classification of railroad assets 106 and/or railroad asset subcomponents, the real-time defect detector 132 may use computer vision techniques to determine whether the image data indicates any immediate defects with the detected railroad assets 106.

The real-time object classifier 130 may use deep learning systems, for example based on neural networks and/or other machine learning systems, to detect portions of an image that are likely to depict railroad assets 106 and/or distinct subcomponents of railroad assets 106. The real-time object classifier 130 may also use such deep learning systems to classify the detected railroad assets 106 and/or the detected railroad asset subcomponents, for instance by identifying or predicting types of the detected railroad assets 106 and/or the detected railroad asset subcomponents.

In some examples, the real-time object classifier 130 may be trained, using supervised or unsupervised machine learning techniques, based on example images. In examples using supervised machine learning techniques, the example images may be associated with labeling data that identifies portions of the example images that depict particular types of railroad assets 106 and/or particular types of railroad asset subcomponents. The real-time object classifier 130 may be trained to process the example images until the real-time object classifier 130 is able to identify, with at least a threshold degree of accuracy, the types and locations of railroad assets 106 and railroad asset subcomponents depicted in the example images that are indicated by the labeling data. For instance, if the real-time object classifier 130 is not able to identify the types and locations of railroad assets 106 and railroad asset subcomponents in the example images that are indicated by the labeling data to at least the threshold degree of accuracy, one or more parameters of the real-time object classifier 130 may be modified, and training of the real-time object classifier 130 may continue based on the modified parameters. Training of the real-time object classifier 130 may accordingly continue until the real-time object classifier 130 can identify the types and locations of railroad assets 106 and railroad asset subcomponents in the example images that are indicated by the labeling data with at least the threshold degree of accuracy.

In examples using unsupervised machine learning techniques, the real-time object classifier 130 may be trained to detect classes of similar elements depicted in the example images. The detected classes may be evaluated and labeled, for instance to indicate to the real-time object classifier 130 that a detected class of element is a particular type of railroad asset 106 or a particular type of a railroad asset subcomponent.

After the real-time object classifier 130 has been trained, for example by the remote computing system 118 or another off-board computing system, a trained version of the real-time object classifier 130 may be deployed to execute via the on-board computing system 102. For example, the real-time asset analyzer 112 executed by the on-board computing system 102 may use the real-time object classifier 130 to process new image data captured by the camera 108, for instance to detect and classify railroad assets 106 and railroad asset subcomponents depicted in new image data captured by the camera 108.

As discussed above, the real-time object classifier 130 may be trained to identify and classify railroad assets 106 depicted in image data captured by the camera 108, and may also be trained to identify and classify subcomponents of railroad assets 106 depicted in image data captured by the camera 108. As an example, if the real-time object classifier 130 determines that a group of pixels of a captured image are likely to collectively depict a railroad switch, the real-time object classifier 130 may subdivide that group of pixels into smaller groups of pixels that are likely to respectively depict distinct subcomponents of the railroad switch, such as closure rails, guard rails, frogs, and/or other elements. As another example, if the real-time object classifier 130 determines that a group of pixels of a captured image are likely to collectively depict a railroad crossing, the real-time object classifier 130 may subdivide that group of pixels into smaller groups of pixels that are likely to respectively depict distinct subcomponents of the railroad crossing, such as rails, a roadway, and/or other elements. As yet another example, if the real-time object classifier 130 determines that a group of pixels of a captured image are likely to collectively depict a railroad bridge, the real-time object classifier 130 may subdivide that group of pixels into smaller groups of pixels that are likely to respectively depict distinct subcomponents of the railroad bridge, such as rails, a bridge interface, a bridge deck, railings or fences extending along edges of the bridge deck, and/or other elements.

In some examples, the real-time object classifier 130 may be configured to use compact asset data 114 to help detect and/or classify railroad assets 106 and railroad asset subcomponents depicted in new image data captured by the camera 108. For example, the real-time object classifier 130 may evaluate a new image captured by the camera 108 and predict, with a relatively low confidence level, that a particular portion of the image depicts a railroad switch. However, if the compact asset data 114 indicates that a railroad switch is expected to be present at or near the geographical location depicted by that particular portion of the new image, the real-time object classifier 130 may increase the confidence level of its prediction that the particular portion of the new image depicts a railroad switch.

When the real-time object classifier 130 evaluates a newly-captured image, and detects and classifies railroad assets 106 and/or railroad asset subcomponents shown in the image, the real-time defect detector 132 may use computer vision techniques and/or perform other operations to determine whether the image indicates defects or other issues with the detected elements. The real-time defect detector 132 may use curve fitting operations, gradient detection operations, and/or other computer vision operations to evaluate the shape and/or location of an element detected in the image, and to determine whether the shape and/or location of the element indicates a defect with the element. In some examples, the real-time defect detector 132 may be trained, using machine learning techniques, based on example images that depict examples of railroad assets 106 and subcomponents of railroad assets 106 that have defects and/or that do not have defects, until the real-time defect detector 132 is able to predict whether the example images do or do not indicate defects with railroad assets 106 to at least a threshold degree of accuracy. Accordingly, after the real-time defect detector 132 has been trained, for example by the remote computing system 118 or another off-board computing system, a trained version of the real-time defect detector 132 may be deployed to execute via the on-board computing system 102 to identify defects with railroad assets 106 that are shown in new image data captured by the camera 108 and that have been identified by the real-time object classifier 130.

As an example, if the real-time object classifier 130 determines that a particular portion of a captured image depicts a rail, the real-time defect detector 132 may further evaluate that particular portion of the captured image to determine whether the particular portion of the captured image shows a defect in the rail. For instance, the real-time defect detector 132 may be configured to use computer vision operations to determine whether the rail depicted via the particular portion of the captured image is bent an angle that exceeds a threshold angle, or is otherwise shaped such that the rail may be buckled in a way that poses safety risks or is indicative of other defects.

As another example, the real-time object classifier 130 may determine that a particular portion of a captured image depicts a railroad switch, and that a smaller segment of that particular portion of the captured image depicts a frog of the railroad switch. In this example, the real-time defect detector 132 may further evaluate the smaller segment of the particular portion of the captured image that depicts the frog, to determine whether the image shows damage to the frog.

If the real-time defect detector 132 evaluates newly-captured image data and identifies a defect in a railroad asset 106 or a railroad asset subcomponent shown in the newly-captured image data, the real-time asset analyzer 112 may output one or more defect alerts 120 associated with the defect. Such defect alerts 120 may identify the type and/or location of the railroad asset 106 or railroad asset subcomponent that has the defect, indicate the type of defect with the railroad asset 106 or railroad asset subcomponent, and/or indicate other information about the detected defect. As an example, the real-time asset analyzer 112 may output a defect alert 120 to an on-board user interface of the railroad vehicle 104, for instance via a dashboard display of a locomotive, to alert an operator of the railroad vehicle 104 about the detected defect. As another example, the real-time asset analyzer 112 may transmit a defect alert 120 to the remote computing system 118, for instance so that the remote computing system 118 may dispatch workers to inspect and/or correct the detected defect.

Accordingly, in some examples, when the real-time object classifier 130 evaluates a new image captured by the camera 108 in order to detect and classify railroad assets 106 and/or railroad asset subcomponents shown in the image, the real-time defect detector 132 may further process the new image to determine whether the image shows any defects associated with the railroad assets 106 and/or railroad asset subcomponents detected by the real-time object classifier 130. However, when the real-time object classifier 130 detects and classifies railroad assets 106 and/or railroad asset subcomponents depicted in a new image captured by the camera 108, the on-board computing system 102 may also or alternately generate new or updated compact asset data 114 associated with the detected railroad assets 106 and/or railroad asset subcomponents depicted in the new image. As discussed above, the compact asset data 114 may use vectors, splines, polygons, and/or other types of data to represent the shapes and locations of detected railroad assets 106 and/or railroad asset subcomponents.

For example, if the real-time object classifier 130 determines that a portion of an image newly-captured by the camera 108 likely shows a section of rail, the on-board computing system 102 may generate or update rail data 126, in compact asset data 114, that uses vectors or splines to represent the shape and/or location of the section of rail detected by the real-time object classifier 130. As another example, if the real-time object classifier 130 determines that a portion of an image newly-captured by the camera 108 likely shows another type of railroad asset 106, or a particular type of subcomponent of a railroad asset 106, the on-board computing system 102 may generate or update other asset data 128, in compact asset data 114, that uses polygons to represent the shape and/or location of the railroad asset 106 or railroad asset subcomponent detected by the real-time object classifier 130.

In some examples, when the on-board computing system 102 generates new or updated compact asset data 114 based on detections of types of railroad assets 106 and/or railroad asset subcomponents by the real-time object classifier 130, the on-board computing system 102 may store new or updated compact asset data 114 in local memory of the on-board computing system 102. In other examples, the on-board computing system 102 may also or alternately send a compact asset data update 122, corresponding to the new or updated compact asset data 114, to the remote computing system 118. Accordingly, as discussed above, the remote computing system 118 may use the compact asset data update 122 to update a remote repository of compact asset data 114 with the new or updated compact asset data 114 determined by the on-board computing system 102.

One or more instances of the asset change detector 124, for example executing locally via the on-board computing system 102 and/or executing remotely via the remote computing system 118, may use the compact asset data 114 to detect changes with railroad assets 106 and/or railroad asset subcomponents over time. Such changes may be indicative of defects with the railroad assets 106 and/or railroad asset subcomponents that may or may not be detectable by the real-time defect detector 132. For example, while the real-time defect detector 132 may be able to detect a sharp bend in a rail that poses a safety risk based on a single image of the rail taken at one point in time, the real-time defect detector 132 may not be configured to determine whether a rail has been slowly drifting and changing position over a longer period of time due to a defect. However, as discussed above, the asset change detector 124 may compare new or updated compact asset data 114 that indicates the current or most-recently determined state of railroad assets 106 against historical compact asset data 114 that indicates previous states of the same railroad assets 106 at one or more earlier points in time, to identify any corresponding changes in the railroad assets 106 over a period of time.

In some examples, the asset change detector 124 may be configured to compare new compact asset data 114 against older compact asset data 114 associated with similar time of day and/or similar weather conditions. For example, rails may be expected to expand and slightly change shape and/or position during the day or during the summer due to warm temperatures, relative to the shapes and positions of the rails at night and/or during cooler temperatures. Accordingly, the asset change detector 124 may be configured to compare the shape and/or position of railroad assets 106 indicated by new compact asset data 114 against shapes and/or positions of those railroad assets 106 at similar times of day and/or similar weather conditions indicated by historical compact asset data 114, rather than comparing the new compact asset data 114 against shapes and/or positions of those railroad assets 106 indicated by historical compact asset data 114 associated with different times of day and/or different weather conditions. This may help avoid false positives in which changes in the states of railroad assets 106 over time are due to weather or other natural or expected conditions instead of defects.

If the asset change detector 124 identifies a defect in a railroad asset 106 or a railroad asset subcomponent shown based on a comparison of compact asset data 114, the asset change detector 124 may output one or more defect alerts 120 associated with the defect. Such defect alerts 120 may identify the type and/or location of the railroad asset 106 or railroad asset subcomponent that has the defect, indicate the type of defect with the railroad asset 106 or railroad asset subcomponent, and/or indicate other information about the detected defect. As an example, an instance of the asset change detector 124 that executes via the on-board computing system 102 may output a defect alert 120 to an on-board user interface of the railroad vehicle 104, for instance via a dashboard display of a locomotive, to alert an operator of the railroad vehicle 104 about the detected defect. As another example, an instance of the asset change detector 124 that executes via the on-board computing system 102 may transmit a defect alert 120 to the remote computing system 118, for instance so that the remote computing system 118 may dispatch workers to inspect and/or correct the detected defect. As yet another example, an instance of the asset change detector 124 that executes via the remote computing system 118 may display a defect alert 120 to a user of the remote computing system 118 or output a defect alert 120 to another entity, for instance so that workers may be dispatched to inspect and/or correct the detected defect in response to the defect alert 120.

In some examples, multiple railroad vehicles 104 may have respective instances of the on-board computing system 102. Accordingly, on-board computing systems 102 associated with different rail vehicles 104 may monitor railroad assets 106 using the real-time asset analyzer 112 and/or compact asset data 114 at different times and/or different locations. For example, a first on-board computing system 102 associated with a first railroad vehicle 104 that travels through a particular geographical area at a first point in time may generate first compact asset data 114 representing the state of railroad assets 106 within the particular geographical area at the first point in time. The on-board computing system 102 may upload the generated first compact asset data 114 to the remote computing system 118 via a compact asset data update 122. A second on-board computing system 102 associated with a second railroad vehicle 104 that travels through a particular geographical area at a second point in time may generate second compact asset data 114 representing the state of railroad assets 106 within the particular geographical area at the second point in time. The second on-board computing system 102 may have downloaded the first compact asset data 114 from the remote computing system 118, such that the asset change detector 124 executed by the second on-board computing system 102 may detect defects by comparing the newly-generated second compact asset data 114 against the previous first compact asset data 114. Alternatively, the second on-board computing system 102 may upload the newly-generated second compact asset data 114 to the remote computing system 118 via a compact asset data update 122, such that the asset change detector 124 executed by the remote computing system 118 may detect defects by comparing the new second compact asset data 114 against the previously-received first compact asset data 114.

In some examples, the remote computing system 118 and/or other entities may assign the on-board computing systems 102 of particular railroad vehicles 104 to perform particular tasks associated with compact asset data 114 and/or the asset change detector 124. As an example, while the on-board computing system 102 of every railroad vehicle 104 may be configured to use the real-time asset analyzer 112 to identify defects in real-time that may pose immediate safety risks to the railroad vehicle 104, the remote computing system 118 may assign one railroad vehicle 104 per day that is scheduled to travel through a particular area to use its on-board computing system 102 to generate new or updated compact asset data 114 associated with that particular area. As another example, the remote computing system 118 may instruct the on-board computing systems 102 of multiple railroad vehicles 104 per day that travel through a particular area to generate new or updated rail data 126, but only instruct the on-board computing systems 102 of one or two railroad vehicles 104 per week that travel through a particular area to generate new or updated other asset data 128 associated with particular types of non-rail infrastructure elements.

In some examples, if an on-board computing system 102 of a railroad vehicle 104 is configured to use a locally-executed asset change detector 124 to detect defects by comparing older compact asset data 114 against newly-generated compact asset data 114, the on-board computing system 102 may download a portion of such older compact asset data 114 associated with a route that will be traveled by the railroad vehicle 104. Accordingly, prior to the railroad vehicle 104 traveling through a particular route, the on-board computing system 102 of the railroad vehicle 104 may download historical compact asset data 114 associated with geographical areas along that particular route from the remote computing system 118. The on-board computing system 102 may thus use the downloaded compact asset data 114 as a base of comparison against new or updated compact asset data 114 generated by the on-board computing system 102 during travel through the particular area, even if that particular area does not have cellular service or the communication interface 116 associated with the on-board computing system 102 otherwise is unable to communicate wirelessly with the remote computing system 118 as the railroad vehicle 104 is traveling through the particular area.

In some examples, when the on-board computing system 102 downloads compact asset data 114 associated with a particular area from the remote computing system 118, the on-board computing system 102 may download the most recent compact asset data 114 for that particular area from the remote computing system 118. In other examples, the on-board computing system 102 may download historical compact asset data 114 associated with the particular area over a recent timeframe from the remote computing system 118, such as sets of compact asset data 114 generated over the last week, last month, last three months, or other period of time. In these examples, the remote computing system 118 may maintain historical compact asset data 114 associated with longer timeframes than are downloaded by the on-board computing system 102.

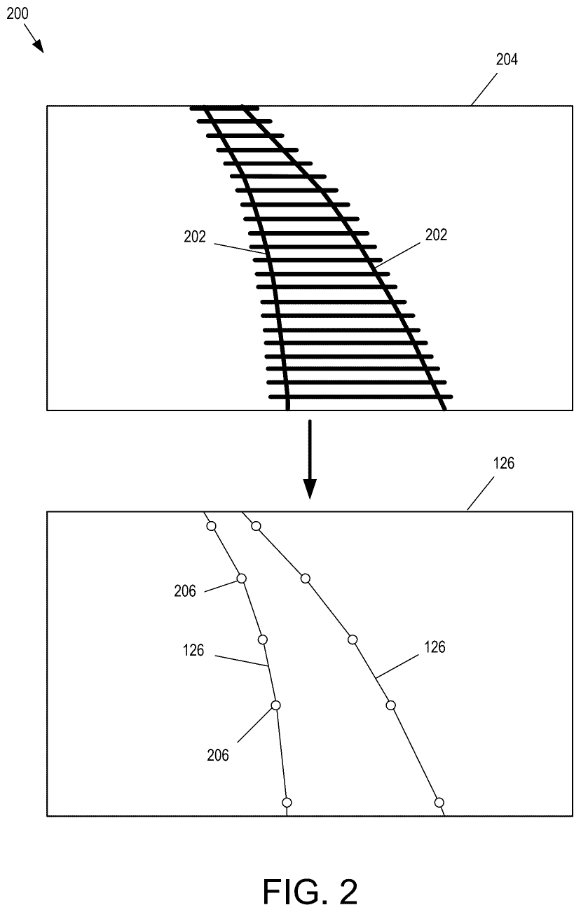

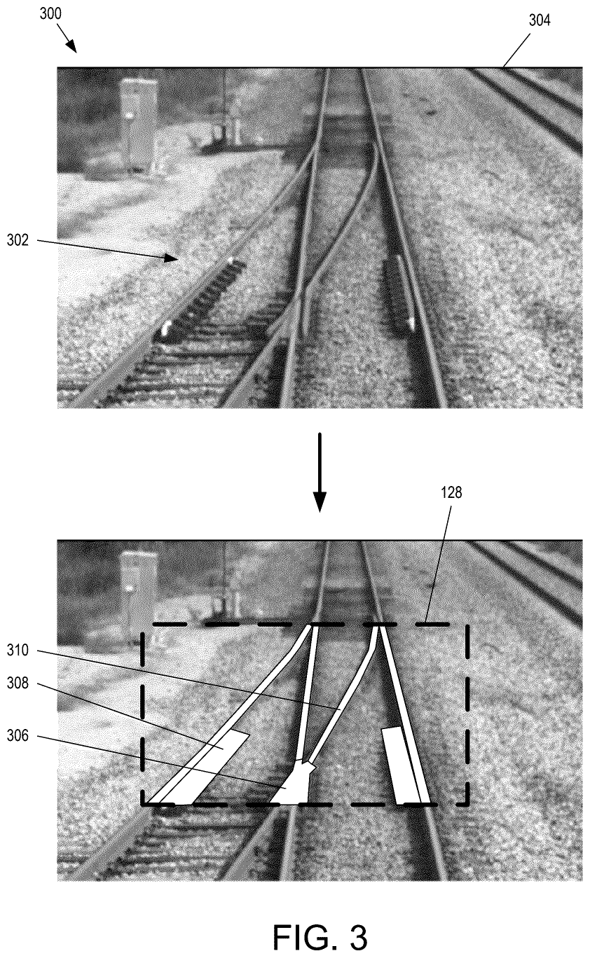

Overall, the on-board computing system 102 may generate compact asset data 114 indicating states of railroad assets 106 and/or railroad asset subcomponents, based on on-board identification and classification of the railroad assets 106 and/or railroad asset subcomponents depicted in image data captured by the camera 108 on the railroad vehicle 104. The on-board computing system 102 may use the real-time defect detector 132 to evaluate the image data, to determine whether the image data indicates any immediate defects with the railroad assets 106 and/or railroad asset subcomponents. However, the on-board computing system 102 and/or the remote computing system 118 may also, or alternately, use the asset change detector 124 to evaluate and compare compact asset data 114, for instance to determine if compact asset data 114 associated with a period of time indicates that railroad assets 106 and/or railroad asset subcomponents have changed over the period of time due to a defect or other issue. Examples of compact asset data 114 are discussed further below with respect to FIG. 2 and FIG. 3.

FIG. 2 shows an example 200 of rail data 126 that indicates, as compact asset data 114, the shapes and locations of rails 202 that are depicted in image data 204 captured by the camera 108 on the railroad vehicle 104. The camera 108 on the railroad vehicle 104 may capture image data 204 depicting elements within a field of view 110 that is at least partially in front of the railroad vehicle 104. As shown in FIG. 2, the image data 204 may depict railroad assets 106, including rails 202.

The real-time asset analyzer 112 of the on-board computing system 102 may use the real-time object classifier 130 to detect and/or classify railroad assets 106 depicted in the image data 204. For example, the real-time object classifier 130 may use deep learning techniques and/or other techniques to identify pixels of the image data 204 that are likely to depict rails 202, and/or to generate a classification determination indicating that those pixels of the image data 204 likely depict rails 202.

In some examples, the on-board computing system 102 may also use GPS and/or other location or positional data, image processing techniques, and/or other systems to determine the geographic location of the area depicted by the image data 204, and/or to determine geographic coordinates of points on and along the identified rails 202. For instance, if the image data 204 depicts multiple sets of rails 202, GPS data and/or heading data may assist the on-board computing system 102 to determine which set of rails 202 the railroad vehicle 104 was traveling on, distinguish that set of rails 202 from an adjacent second set of rails 202 also depicted in the image data 204, and determine geographic coordinates of points on and along one or both sets of rails 202. Similarly, the on-board computing system 102 may use compact asset data 114 and/or other information associated with non-rail railroad assets 106 to determine or infer the geographic location of the area depicted by the image data 204 and/or the geographic coordinates of points on and along the identified rails 202. For instance, the on-board computing system 102 may use compact asset data 114 and/or other predetermined information to determine that, based on the predetermined or newly-determined locations of one or more switches, bridges, and/or other non-rail railroad assets 106, the railroad vehicle 104 was likely located at a particular geographical location when the image data 204 was captured.

In some examples, the real-time asset analyzer 112 of the on-board computing system 102 may use the real-time defect detector 132 to determine if the image data 204 indicates any immediate defects with the identified rails 202. For example, the real-time defect detector 132 may use computer vision techniques to evaluate pixels of the image data 204 that the real-time object classifier 130 determined are likely to depict rails 202, for instance to determine if the image data 204 indicates that the rails 202 are shaped with bends indicative of buckling.

However, the on-board computing system 102 may also, or alternately, use the identification of the rails 202 in the image data 204 by the real-time object classifier 130 to generate the rail data 126 as shown in FIG. 2. For example, based on image processing operations and/or other operations that identify the shape and location of a rail 202 shown in the image data 204, the on-board computing system 102 may determine a vector or spline that fits a subset of coordinates 206 along that rail 202 and that thus defines the shape and location of the rail 202.

Accordingly, the rail data 126 may use vectors and/or splines to represent the shapes and locations of identified rails 202. The vectors and/or splines of the rail data 126 may use less data to represent the shapes and locations of identified rails 202, relative to the original image data 204 or other potential representations of the identified rails 202. For example, the vectors and/or splines of the rail data 126 that represent the shapes and locations of identified rails 202 may be stored and/or transmitted using less data, and thus less memory or bandwidth, than high resolution images or high density point cloud data that may otherwise depict or represent the shapes and locations of identified rails 202.

The rail data 126 shown in FIG. 2 may represent the state of the identified rails 202 at a point in time at which the image data 204 was captured by the camera 108. The asset change detector 124 may compare the rail data 126 shown in FIG. 2 against other rail data 126 representing the state of the same rails 202 at earlier and/or later points in time, for instance to determine whether the rails 202 have changed shape and/or position over a longer period of time due to a defect or other issue. Although FIG. 2 shows an example in which compact asset data 114 is rail data 126 representing identified rails 202, compact asset data 114 may also or alternately include other asset data 128 representing other types of railroad assets 106 and/or subcomponents of railroad assets 106, as discussed further below with respect to FIG. 3.

FIG. 3 shows an example 300 of other asset data 128 that indicates, as compact asset data 114, the shapes and locations of subcomponents of a railroad switch 302 that are depicted in image data 304 captured by the camera 108 on the railroad vehicle 104. The camera 108 on the railroad vehicle 104 may capture image data 304 depicting elements within a field of view 110 that is at least partially in front of the railroad vehicle 104. As shown in FIG. 3, the image data 304 may depict railroad assets 106, including the railroad switch 302.

The real-time asset analyzer 112 of the on-board computing system 102 may use the real-time object classifier 130 to detect and/or classify railroad assets 106 depicted in the image data 304. For example, the real-time object classifier 130 may use deep learning techniques and/or other techniques to identify pixels of the image data 304 that are likely to depict a railroad switch 302 overall, and/or to generate a classification determination indicating that those pixels of the image data 304 likely depict a railroad switch 302. The real-time object classifier 130 may also use deep learning techniques and/or other techniques to identify and/or classify smaller groups of pixels of the image data 304 that are likely to depict corresponding subcomponents of the railroad switch 302, such as distinct groups of pixels that respectively depict a frog 306, a guard rail 308, a closure rail 310, and/or other subcomponents of the railroad switch 302.

In some examples, the on-board computing system 102 may also use GPS and/or other location or positional data, image processing techniques, and/or other systems to determine the geographic location of the area depicted by the image data 304, and/or to determine geographic coordinates of points on the identified railroad switch 302 and/or the identified subcomponents of the railroad switch 302. For example, the on-board computing system 102 may use compact asset data 114 and/or other information associated with railroad assets 106 to determine or infer the geographic location of the area depicted by the image data 204 and/or the geographic coordinates of points on the railroad switch 302 or its subcomponents. For instance, the on-board computing system 102 may use compact asset data 114 and/or other predetermined information to determine that, based on the predetermined or newly-determined locations of one or more other switches, bridges, and/or other non-rail railroad assets 106, the railroad vehicle 104 was likely located at a particular geographical location when the image data 304 was captured.

In some examples, the on-board computing system 102 may also use the image data 304, and/or other image data captured before and/or after the image data 304, to determine or infer the location of the railroad vehicle 104 and/or a path traveled by the railroad vehicle 104. For instance, based on the image data 304 depicting the railroad switch 302 and earlier and/or later image data depicting rails, the on-board computing system 102 may determine whether the railroad vehicle 104 followed a right path or a left path due to the railroad switch 302. A history of GPS data and/or other location or positional data may also, or alternately, indicate a travel path of the railroad vehicle 104. Such information about the travel path of the railroad vehicle 104 may provide contextual information that may assist the on-board computing system 102 in determining locations of particular railroad assets 106 identified along the travel path.

In some examples, the real-time asset analyzer 112 of the on-board computing system 102 may use the real-time defect detector 132 to determine if the image data 304 indicates any immediate defects with the identified railroad switch 302 and/or the identified subcomponents of the railroad switch 302. For example, the real-time defect detector 132 may use computer vision techniques to evaluate pixels of the image data 304 that the real-time object classifier 130 determined are likely to depict the railroad switch 302 and/or subcomponents of the railroad switch 302, for instance to determine if the image data 304 indicates damage to the railroad switch 302 overall or to one or more individual subcomponents of the railroad switch 302.

However, the on-board computing system 102 may also, or alternately, use the identification of the railroad switch 302 and/or the subcomponents of the railroad switch 302 in the image data 304 by the real-time object classifier 130 to generate the other asset data 128 as shown in FIG. 3. For example, based on image processing operations and/or other operations that identify the shape, orientation, and/or location of the frog 306 shown in the image data 304, the on-board computing system 102 may determine a polygon that represents the shape, orientation, and/or location of the frog 306 within the overall railroad switch 302. Similarly, based on image processing operations and/or other operations that identify the shape, orientation, and/or location of a guard rail 308 shown in the image data 304, the on-board computing system 102 may determine a polygon that represents the shape, orientation, and/or location of that guard rail 308 within the overall railroad switch 302.

In some examples, the on-board computing system 102 may also represent other types of identified subcomponents of the railroad switch 302 with corresponding polygons. In other examples, the on-board computing system 102 may be configured to represent some types of identified subcomponents of the railroad switch 302, such as closure rails or other types of rails via vectors and/or splines as rail data 126, instead of via polygons as other asset data 128.

Overall, the other asset data 128 may define polygons to represent the shapes and locations of one or more types of identified subcomponents of the railroad switch 302. The polygons of the other asset data 128 may use less data to represent the shapes and locations of the identified subcomponents of the railroad switch 302, relative to the original image data 304 or other potential representations of the identified subcomponents of the railroad switch 302. For example, coordinates of points defining the polygons of the other asset data 128 that represent the shapes and locations of identified subcomponents of the railroad switch 302 may be stored and/or transmitted using less data, and thus less memory or bandwidth, than high resolution images or high density point cloud data that may otherwise depict or represent the shapes and locations of identified subcomponents of the railroad switch 302.

The other asset data 128 shown in FIG. 3 may represent the state of the identified subcomponents of the railroad switch 302 at a point in time at which the image data 304 was captured by the camera 108. The asset change detector 124 may compare the other asset data 128 shown in FIG. 3 against other asset data 128 representing the state of the same subcomponents of the railroad switch 302 at earlier and/or later points in time, for instance to determine whether the subcomponents of the railroad switch 302 have changed shape and/or position over a longer period of time due to a defect or other issue.

Although FIG. 3 depicts subcomponents of a railroad switch 302, other asset data 128 may represent other types of railroad assets 106 and/or other types of subcomponents of railroad assets 106. For example, if image data captured by the camera 108 depicts a railroad bridge, and the real-time object classifier 130 identifies subcomponents of the railroad bridge depicted in the image data, the on-board computing system 102 may generate other asset data 128 that defines polygons representing the shapes, orientation, and/or locations of the identified subcomponents of the railroad bridge. Similarly, if image data captured by the camera 108 depicts a railroad crossing, and the real-time object classifier 130 identifies subcomponents of the railroad crossing depicted in the image data, the on-board computing system 102 may generate other asset data 128 that defines polygons representing the shapes, orientation, and/or locations of the identified subcomponents of the railroad crossing.

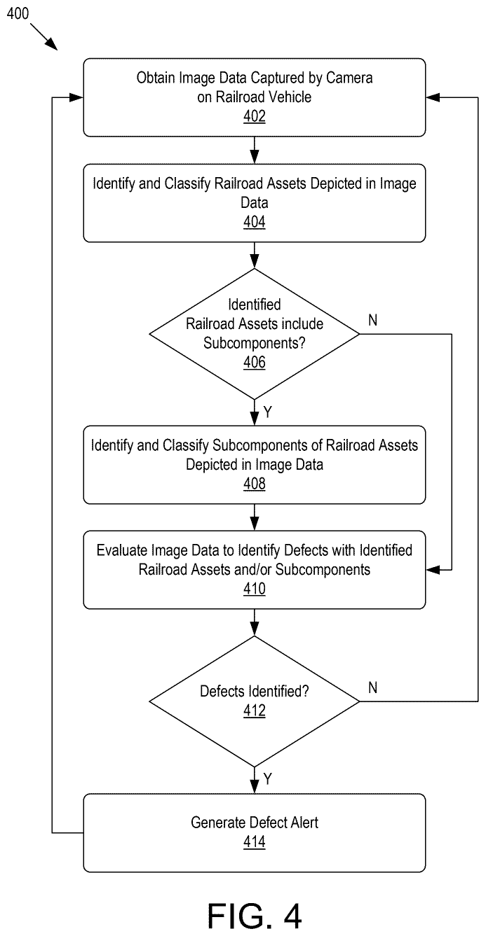

FIG. 4 is a flowchart 400 illustrating an example process for using image data captured by the camera 108 to detect defects with railroad assets 106 and/or subcomponents of railroad assets 106 substantially in real-time. The operations shown in FIG. 4 may be performed by the on-board computing system 102 on the railroad vehicle 104. As discussed above, the on-board computing system 102 may be component of the camera 108 on the railroad vehicle 104, or may be a separate computing system on-board the railroad vehicle 104 that can receive image data captured by the camera 108 on the railroad vehicle 104.

At block 402, the on-board computing system 102 may obtain image data captured by the camera 108 on the railroad vehicle 104. The image data may be still images, video frames, or other image data that depicts an environment in front of and/or around the railroad vehicle 104. For example, the image data may depict an environment within a field of view 110 that is at least partially ahead of the railroad vehicle 104 as the railroad vehicle 104 travels forward along railroad tracks.

At block 404, the on-board computing system 102 may identify and classify railroad assets 106 that are depicted in the image data obtained at block 402. For example, the on-board computing system 102 may use the real-time object classifier 130 to identify portions of the image data that are likely to depict distinct railroad assets 106, and to classify such detected distinct railroad assets 106. For example, the real-time object classifier 130 may be trained to use deep learning and/or other machine learning techniques to identify groups of pixels, or other portions of the image data, that are likely to depict rails, railroad crossings, railroad switches, railroad bridges, and/or other types of railroad assets 106.

At block 406, the on-board computing system 102 may determine if any of the types of railroad assets 106 identified in the image data at block 404 are likely to include subcomponents. For example, if the only railroad assets 106 identified in the image data at block 404 are rails, the rails may not include distinct subcomponents that the on-board computing system 102 is configured to evaluate. However, if the railroad assets 106 identified in the image data at block 404 include crossings, switches, bridges, and/or other relatively complex infrastructure elements, those railroad assets 106 may include one or more types of subcomponents that the on-board computing system 102 is configured to evaluate.

Accordingly, if the types of railroad assets 106 identified in the image data at block 404 are likely to include subcomponents (Block 406—Yes), at block 408 the on-board computing system 102 may use the real-time object classifier 130 to identify and classify the subcomponents of those railroad assets 106 that are depicted in the image data obtained at block 402. For example, the real-time object classifier 130 may be trained to use deep learning and/or other machine learning techniques to identify groups of pixels, or other portions of the image data, that are likely to depict distinct types of subcomponents of one or more types of railroad assets 106.

As an example, if the real-time object classifier 130 determined at block 404 that a particular portion of the image data likely depicts a railroad switch, at block 408 the real-time object classifier 130 may further process that particular portion of the image data to identify smaller segments of the particular portion of the image data that are likely to depict closure rails, guard rails, frogs, and/or other subcomponents of the railroad switch that the real-time object classifier 130 has been trained to identify. As another example, if the real-time object classifier 130 determined at block 404 that a particular portion of the image data likely depicts a railroad crossing, at block 408 the real-time object classifier 130 may further process that particular portion of the image data to identify smaller segments of the particular portion of the image data that are likely to depict crossing rails, a roadway, and/or other subcomponents of the railroad crossing that the real-time object classifier 130 has been trained to identify. As yet another example, if the real-time object classifier 130 determined at block 404 that a particular portion of the image data likely depicts a railroad bridge, at block 408 the real-time object classifier 130 may further process that particular portion of the image data to identify smaller segments of the particular portion of the image data that are likely to depict bridge rails, a bridge interface, a bridge deck, railings or fences extending along edges of the bridge deck, and/or other subcomponents of the railroad bridge that the real-time object classifier 130 has been trained to identify.

After identifying and classifying railroad assets 106 depicted in the image data at block 404, and after identifying and classifying corresponding subcomponents of those railroad assets 106 at block 408 or determining at block 406 that the identified railroad assets 106 do not include subcomponents (Block 406-No), the on-board computing system 102 may further evaluate portions of the image data that have been found to depict corresponding railroad assets 106 and/or railroad asset subcomponents. For example, at block 410 the on-board computing system 102 may use the real-time defect detector 132 to evaluate the image data and identify defects, if any, with the railroad assets 106 and/or railroad asset subcomponents depicted in the image data.

As an example, if a first portion of the image data has been determined to depict rails, the real-time defect detector 132 may use computer vision techniques to determine whether the shape of the rails shown in that first portion of the image data indicates that the rails are buckling or have another defect. As another example, if a second portion of the image data has been determined to depict a railroad switch, the real-time defect detector 132 may use computer vision techniques to determine whether the second portion of the image data indicates damage to, or other defects with, the railroad switch as a whole. Additionally, because the real-time object classifier 130 may have determined that distinct smaller sections of the second portion of the image that depicts the railroad switch respectively depict subcomponents of the railroad switch, such as such as closure rails, guard rails, and a frog, the real-time defect detector 132 may use computer vision techniques to determine whether the smaller sections of the second portion of the image data respectively indicate damage to, or other defects with, any of the individual components of the railroad switch.

At block 412, the on-board computing system 102 may determine whether any defects with railroad assets 106 and/or railroad asset subcomponents were identified at block 410. If no defects were identified at block 410 (Block 412-No), the on-board computing system 102 may return to block 402 to obtain additional image data that may be evaluated via the process shown in FIG. 4. For example, the railroad vehicle 104 may have traveled to a point further along railroad tracks, and the additional image data may depict railroad assets 106 present in a geographical area that is further along the railroad tracks.

If one or more defects were identified at block 410 (Block 412—Yes), the on-board computing system 102 may generate and/or output corresponding defect alerts 120 at block 414. For example, the on-board computing system 102 may display a defect alert 120, corresponding to a defect identified at block 410, to an operator of the railroad vehicle 104 at block 414, and/or may transmit the same or a similar defect alert to the remote computing system 118. In addition to generating a defect alert 120 at block 414, the on-board computing system 102 may return to block 402 to obtain additional image data that may be evaluated via the process shown in FIG. 4.

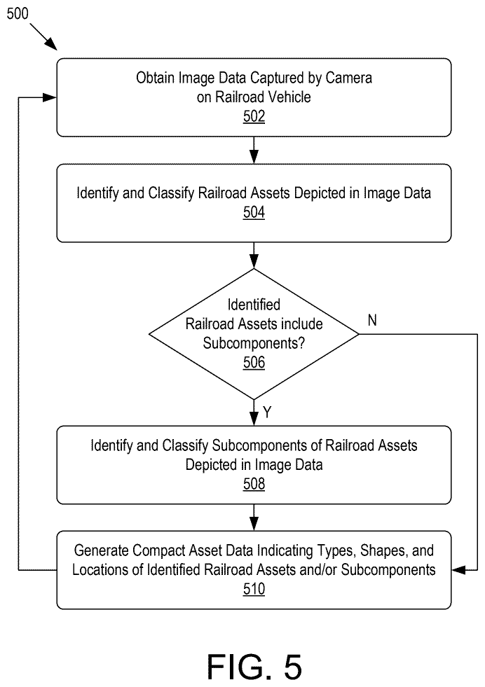

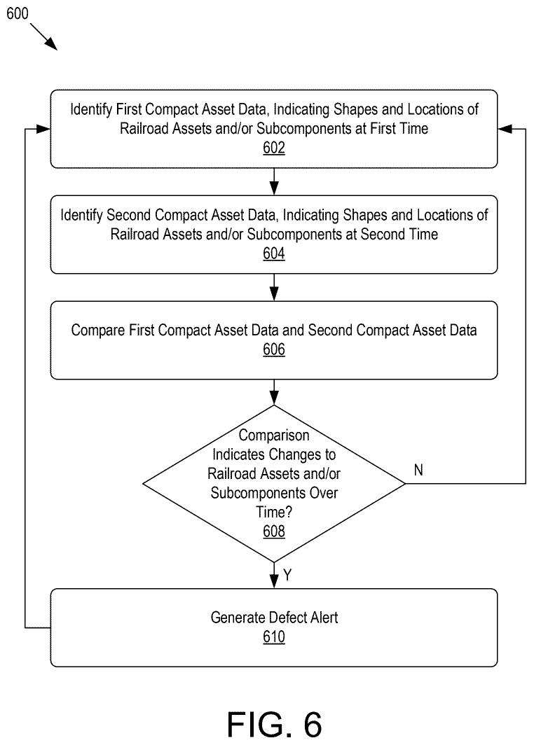

In the process shown in FIG. 4, the identifications and classifications by the on-board computing system 102 of railroad assets 106 and/or subcomponents of railroad assets 106 depicted in image data may be used by the real-time defect detector 132 to detect defects based on analysis of the image data captured at a particular point in time. However, as discussed further below with respect to FIG. 5, the identifications and classifications by the on-board computing system 102 of railroad assets 106 and/or subcomponents of railroad assets 106 depicted in image data may also, or alternately, be used to generate compact asset data 114 that represent the types, shapes, and locations of the identified railroad assets 106 and/or railroad asset subcomponents at a point in time. As discussed further below with respect to FIG. 6, the compact asset data 114 indicating the state of railroad assets 106 and/or railroad asset subcomponents at one point in time may be compared against other compact asset data 114 indicating the state of those railroad assets 106 and/or railroad asset subcomponents at one or more other times, to determine whether the shapes and/or locations of the railroad assets 106 and/or railroad asset subcomponents have changed over time due to defects or other issues.

FIG. 5 is a flowchart 500 illustrating an example process for using image data captured by the camera 108 to generate compact asset data 114 indicative of the types, shapes, and/or locations of railroad assets 106 and/or subcomponents of railroad assets 106 depicted in the image data. The operations shown in FIG. 5 may be performed by the on-board computing system 102 on the railroad vehicle 104. As discussed above, the on-board computing system 102 may be component of the camera 108 on the railroad vehicle 104, or may be a separate computing system on-board the railroad vehicle 104 that can receive image data captured by the camera 108 on the railroad vehicle 104.

At block 502, the on-board computing system 102 may obtain image data captured by the camera 108 on the railroad vehicle 104. The image data may be still images, video frames, or other image data that depicts an environment in front of and/or around the railroad vehicle 104. For example, the image data may depict an environment within a field of view 110 that is at least partially ahead of the railroad vehicle 104 as the railroad vehicle 104 travels forward along railroad tracks.

At block 504, the on-board computing system 102 may identify and classify railroad assets 106 that are depicted in the image data obtained at block 502. For example, the on-board computing system 102 may use the real-time object classifier 130 to identify portions of the image data that are likely to depict distinct railroad assets 106, and to classify such detected distinct railroad assets 106. For example, the real-time object classifier 130 may be trained to use deep learning and/or other machine learning techniques to identify groups of pixels, or other portions of the image data, that are likely to depict rails, railroad crossings, railroad switches, railroad bridges, and/or other types of railroad assets 106.

At block 506, the on-board computing system 102 may determine if any of the types of railroad assets 106 identified in the image data at block 504 are likely to include subcomponents. For example, if the only railroad assets 106 identified in the image data at block 504 are rails, the rails may not include distinct subcomponents that the on-board computing system 102 is configured to evaluate. However, if the railroad assets 106 identified in the image data at block 504 include crossings, switches, bridges, and/or other relatively complex infrastructure elements, those railroad assets 106 may include one or more types of subcomponents that the on-board computing system 102 is configured to evaluate.

Accordingly, if the types of railroad assets 106 identified in the image data at block 504 are likely to include subcomponents (Block 506—Yes), at block 508 the on-board computing system 102 may use the real-time object classifier 130 to identify and classify the subcomponents of those railroad assets 106 that are depicted in the image data obtained at block 502. For example, the real-time object classifier 130 may be trained to use deep learning and/or other machine learning techniques to identify groups of pixels, or other portions of the image data, that are likely to depict distinct types of subcomponents of one or more types of railroad assets 106.

As an example, if the real-time object classifier 130 determined at block 504 that a particular portion of the image data likely depicts a railroad switch, at block 508 the real-time object classifier 130 may further process that particular portion of the image data to identify smaller segments of the particular portion of the image data that are likely to depict closure rails, guard rails, frogs, and/or other subcomponents of the railroad switch that the real-time object classifier 130 has been trained to identify. As another example, if the real-time object classifier 130 determined at block 504 that a particular portion of the image data likely depicts a railroad crossing, at block 508 the real-time object classifier 130 may further process that particular portion of the image data to identify smaller segments of the particular portion of the image data that are likely to depict crossing rails, a roadway, and/or other subcomponents of the railroad crossing that the real-time object classifier 130 has been trained to identify. As yet another example, if the real-time object classifier 130 determined at block 504 that a particular portion of the image data likely depicts a railroad bridge, at block 508 the real-time object classifier 130 may further process that particular portion of the image data to identify smaller segments of the particular portion of the image data that are likely to depict bridge rails, a bridge interface, a bridge deck, railings or fences extending along edges of the bridge deck, and/or other subcomponents of the railroad bridge that the real-time object classifier 130 has been trained to identify.

After identifying and classifying railroad assets 106 depicted in the image data at block 504, and after identifying and classifying corresponding subcomponents of those railroad assets 106 at block 508 or determining at block 506 that the identified railroad assets 106 do not include subcomponents (Block 506-No), the on-board computing system 102 may generate compact asset data 114 that represents the identified railroad assets 106 and/or railroad asset subcomponents at block 510. As discussed above, the compact asset data 114 may include rail data 126 and/or other asset data 128.

As an example, if the on-board computing system 102 determined that portions of the image data depict rails, the on-board computing system 102 may evaluate those portions of the image data to determine vectors and/or splines that define the shapes of one or more sections of the depicted rails, along with three-dimensional coordinates of points that define the locations of the vectors and/or splines that represent the rail sections. The on-board computing system 102 may generate rail data 126 that defines the vectors and/or splines, and/or corresponding coordinates, that represent the locations and shapes of the detected rails. Accordingly, the rail data 126 may use vectors, splines, and/or corresponding coordinates to represent the shape and location of identified sections of rails with less data than would be used to store full image data or point cloud data that indicates the location of numerous distinct points along the identified rails.

As another example, if the on-board computing system 102 determined that a portion of the image data depicts a railroad switch, and that distinct sections of that portion of the image data respectively depict closure rails, guard rails, frogs, and/or other subcomponents of the railroad switch, the on-board computing system 102 may evaluate the image data to determine polygons and/or corresponding coordinates that represent the shapes, orientations, and locations of the identified subcomponents of the railroad switch. The on-board computing system 102 may generate other asset data 128 that defines the polygons, and/or corresponding coordinates, that represent distinct types of detected subcomponents of the railroad switch. Accordingly, the other asset data 128 may use polygons and/or corresponding coordinates to represent the shapes, orientations, and locations of identified subcomponents of the railroad switch with less data than would be used to store full image data or point cloud data that indicates the location of numerous distinct points along the identified railroad switch and/or identified subcomponents of the railroad switch. The on-board computing system 102 may similarly generate other asset data 128 that indicates polygons and/or coordinates representative of shapes, orientations, and locations of other identified types of railroad assets 106 and/or identified types of railroad asset subcomponents depicted in the image data, such as railroad bridges, railroad crossings, and/or other types of railroad infrastructure elements.

The compact asset data 114 generated at block 510 may be associated with a point in time that corresponds to the time at which the image data obtained at block 502 was captured by the camera 108. Accordingly, the compact asset data 114 may have a timestamp or other information indicating the point in time that is associated with the compact asset data 114, to indicate that that the compact asset data 114 represents the shapes, orientations, and locations of one or more types of railroad assets 106 and/or railroad asset subcomponents at that point in time.

After generating the compact asset data 114 at block 510, the on-board computing system 102 may also return to block 502 to obtain additional image data that may be evaluated via the process shown in FIG. 5. For example, the railroad vehicle 104 may have traveled to a point further along railroad tracks, and the additional image data may depict railroad assets 106 present in a geographical area that is further along the railroad tracks.

In some examples, the on-board computing system 102 may store the compact asset data 114 generated at block 510 in local memory. Accordingly, the on-board computing system 102 may compare the compact asset data 114 generated at block 510 against other compact asset data 114 associated with other points in time, as discussed further below with respect to FIG. 6. In other examples, the on-board computing system 102 may also, or alternately, send the compact asset data 114 as a compact asset data update 122 to the remote computing system 118. The remote computing system 118 may use the compact asset data update 122 to update a remote repository of compact asset data 114 based on the new newly-generated compact asset data 114. The remote computing system 118 may also, or alternately, compare the newly-generated compact asset data 114 against other compact asset data 114 associated with other points in time, as discussed further below with respect to FIG. 6.

FIG. 6 is a flowchart 600 illustrating an example process for using compact asset data 114 to identify changes, over a period of time, to railroad assets 106 that may be indicative defects or other issues with the railroad assets 106. The operations shown in FIG. 6 may be performed by a computing system, such as the on-board computing system 102 or the remote computing system 118. FIG. 7, discussed further below, describes an example system architecture for such a computing system.

At block 602, the computing system may identify first compact asset data 114 that is associated with a first time. The first compact asset data 114 may include rail data 126 and/or other asset data 128, such as coordinates, vectors, splines, polygons, and/or other data, that shapes, orientations, and/or locations of one or more types of railroad assets 106 and/or railroad asset components at the first time.

At block 604, the computing system may identify second compact asset data 114 that is associated with a second time. The second compact asset data 114 may include rail data 126 and/or other asset data 128, such as coordinates, vectors, splines, polygons, and/or other data, that shapes, orientations, and/or locations of one or more types of railroad assets 106 and/or railroad asset components at the second time.

In some examples, the first compact asset data 114 identified at block 602 may be historical compact asset data 114 associated with one or more railroad assets 106 and/or railroad asset components, while the second compact asset data 114 identified at block 604 may be new compact asset data 114 associated with the same railroad assets 106 and/or railroad asset components. For instance, the first compact asset data 114 and the second compact asset data 114 may be associated with the same geographical area, such that the first compact asset data 114 and the second compact asset data 114 represent states of the same railroad assets 106 present in that geographical area at different times.

In some examples, the computing system that identifies the first compact asset data 114 and the second compact asset data 114 may be an on-board computing system 102 of a railroad vehicle 104. The first compact asset data 114 may be historical compact asset data 114 that was previously determined by the on-board computing system 102 based on image data captured by a camera 108 of the railroad vehicle 104 during a previous trip of the railroad vehicle 104 through a particular geographical area. Alternatively, the first compact asset data 114 may be historical compact asset data 114 that was previously determined by an on-board computing system 102 of a different railroad vehicle 104, based on image data captured by a camera 108 of the different railroad vehicle 104 during a previous trip of the different railroad vehicle 104 through the particular geographical area. The on-board computing system 102 of the different railroad vehicle 104 may have uploaded the first compact asset data 114 to the remote computing system 118, such that the on-board computing system 102 of the railroad vehicle 104 may download the first compact asset data 114 from the remote computing system 118 prior to or during travel through the particular geographical area. In these examples, the second compact asset data 114 may be new compact asset data 114 generated by the on-board computing system 102 of the railroad vehicle 104 during or after a subsequent trip through the particular geographical area.

In other examples, the computing system that identifies the first compact asset data 114 and the second compact asset data 114 may be the remote computing system 118. In some of these examples, the remote computing system 118 may receive the first compact asset data 114 and the second compact asset data 114 from an on-board computing system 102 of a single railroad vehicle 104 that has traveled through the same geographical area at different times, such that the first compact asset data 114 and the second compact asset data 114 represent states of railroad assets 106 at the respective different times. In other examples, the remote computing system 118 may receive the first compact asset data 114 and the second compact asset data 114 from on-board computing systems 102 of different railroad vehicle 104 that have traveled through the same geographical area at different times, such that the first compact asset data 114 and the second compact asset data 114 represent states of railroad assets 106 at the respective different times.

At block 606, the computing system may compare the first compact asset data 114 and the second compact asset data 114 to identify any changes to the railroad assets 106 and/or railroad asset subcomponents over a period of time. For example, the computing system may compare the first compact asset data 114 and the second compact asset data 114 to determine whether the shapes, orientations, and/or locations of one or more railroad assets 106 and/or railroad asset subcomponents indicated by the first compact asset data 114 and the second compact asset data 114 have changed over a period of time between the first time associated with the first compact asset data 114 and the second time associated with the second compact asset data 114.

If the comparison performed at block 606 indicates one or more changes to railroad assets 106 and/or railroad asset subcomponents over the period of time (Block 608—Yes), the computing system may generate a corresponding defect alert 120 at block 610. As an example, if the comparison indicates that the shape and/or location of a particular section of rail changed between the first time associated with the first compact asset data 114 and the second time associated with the second compact asset data 114, the defect alert 120 may indicate the change in shape and/or location of the section of rail. As another example, if the comparison indicates that the shape and/or orientation of a railroad bridge railing changed between the first time associated with the first compact asset data 114 and the second time associated with the second compact asset data 114, the defect alert 120 may indicate the change in shape and/or orientation of the railroad bridge railing.

If the comparison performed at block 606 does not indicate one or more changes to railroad assets 106 and/or railroad asset subcomponents over the period of time (Block 608-No), or if a defect alert 120 is generated at block 610 based on the comparison performed at block 606, the computing system may return to block 602 and may identify an additional pair of first compact asset data 114 and second compact asset data 114 to be compared. For example, the computing system may repeat the process shown in FIG. 6 for first compact asset data 114 and second compact asset data 114 associated with different points in time and/or a different geographical area.

Although FIG. 6 shows a comparison of first compact asset data 114 associated with a first point in time and second compact asset data 114 associated with a second point in time, in some examples the computing system may compare the first compact asset data 114 and/or the second compact asset data 114 against compact asset data 114 associated with additional points in time. For example, if the second compact asset data 114 represents the most recently determined state of railroad assets 106 present within a particular geographical area, the computing system may compare the second compact asset data 114 against compact asset data 114 representing multiple previous states of the same railroad assets 106 in that particular geographical area at multiple previous points in time. This may, for instance, allow the computing system to track changes to the railroad assets 106 over time, determine whether rates of change associated with the railroad assets 106 have been increasing or decreasing, and/or otherwise determine or monitor progressive changes to the railroad assets 106 over one or more windows of time that may be indicative of defects or other issues.

FIG. 7 shows an example system architecture for a computing system 700 that executes one or more elements described in the present disclosure. The computing system 700 may include one or more computing devices, controllers, servers, or other computing elements that include one or more processors 702, memory 704, and/or communication interfaces 706.

In some examples, the computing system 700 may be the on-board computing system 102 present on the railroad vehicle 104. As discussed above, the on-board computing system 102 may be component of the camera 108 on the railroad vehicle 104, or may be a separate computing system that is on-board the railroad vehicle 104. In other examples, the computing system 700 may be the remote computing system 118 that is located remotely from the railroad vehicle 104, such as a separate computer located at a back office, a server, a cloud computing element, or other type of computing system separate from the on-board computing system 102 and the railroad vehicle 104.

In some examples, elements of the railroad asset monitoring system 100 may be distributed among multiple computing systems similar to the computing system 700 shown in FIG. 7. As an example, the on-board computing system 102 may be a first computing system that executes the real-time asset analyzer 112, and that may execute a local instance of the asset change detector 124, while the remote computing system 118 may be a second computing system that executes a remote instance of the asset change detector 124. As another example, the on-board computing system 102 may include multiple computing systems or devices, such as distinct computing devices that separately execute the real-time asset analyzer 112 and the asset change detector 124.

The processor(s) 702 of the computing system 700 may operate to perform a variety of functions as set forth herein. The processor(s) 702 may include one or more chips, microprocessors, application specific integrated circuits (ASICs), field programmable gate arrays (FPGAs) and/or other programmable circuits, central processing units (CPUs), graphics processing units (GPUs), digital signal processors (DSPs), and/or other processing units or components known in the art. As an example, the computing system 700 may be a component of the camera 108 that operates as the on-board computing system 102, and the computing system 700 may have FPGAs and/or other types of processor(s) 702 that are configured to perform deep learning operations and/or computer vision operations to evaluate images captured by image sensors of the camera 108.

In some examples, the processor(s) 702 may have one or more arithmetic logic units (ALUs) that perform arithmetic and logical operations, and/or one or more control units (CUs) that extract instructions and stored content from processor cache memory, and executes such instructions by calling on the ALUs during program execution. The processor(s) 702 may also access content and computer-executable instructions stored in the memory 704, and execute such computer-executable instructions.

The memory 704 may be volatile and/or non-volatile computer-readable media including integrated or removable memory devices including random-access memory (RAM), read-only memory (ROM), flash memory, a hard drive or other disk drives, a memory card, optical storage, magnetic storage, and/or any other computer-readable media. The computer-readable media may be non-transitory computer-readable media. The computer-readable media may be configured to store computer-executable instructions that may be executed by the processor(s) 702 to perform the operations described herein.

For example, the memory 704 may include a drive unit and/or other elements that include machine-readable media. A machine-readable medium may store one or more sets of instructions, such as software or firmware, that embodies any one or more of the methodologies or functions described herein. The instructions may also reside, completely or at least partially, within the processor(s) 702 and/or communication interface(s) 706 during execution thereof by the computing system 700. For example, the processor(s) 702 may possess local memory, which also may store program modules, program data, and/or one or more operating systems.

The memory 704 may store data and/or computer-executable instructions associated with elements of the railroad asset monitoring system 100 described herein. For example, the memory 704 may store data and/or computer-executable instructions associated with the real-time asset analyzer 112, the compact asset data 114, the asset change detector 124, the real-time object classifier 130, the real-time defect detector 132, and/or other elements.

The memory 704 may also store other modules and data 708 that may be utilized by the computing system 700 to perform or enable performing any action taken by the computing system 700. For example, the other modules and data 708 may include a platform, operating system, and/or applications, as well as data utilized by the platform, operating system, and/or applications.

The communication interfaces 706 may include transceivers, modems, interfaces, antennas, and/or other components that may transmit and/or receive data over networks or other data connections. For example, if the computing system 700 is the on-board computing system 102, the communication interfaces 706 may include the communication interface 116 that allows the on-board computing system 102 to send defect alerts 120 and/or compact asset data updates 122 to the remote computing system 118, and/or to download or access compact asset data 114 from the remote computing system 118. Similarly, if the computing system 700 is the remote computing system 118, the communication interfaces 706 may allow the remote computing system 118 to receive defect alerts 120 and/or compact asset data updates 122 from on-board computing systems 102 of one or more railroad vehicles 104, and/or to send compact asset data 114 to the on-board computing systems 102 of one or more railroad vehicles 104.

### INDUSTRIAL APPLICABILITY

As described herein, the on-board computing system 102 on the railroad vehicle 104 may use the real-time asset analyzer 112 to identify railroad assets 106 and/or railroad asset subcomponents depicted in image data captured by the camera 108 on the railroad vehicle 104. The on-board computing system 102 may also use the real-time asset analyzer 112 to identify any immediate defects in railroad assets 106 and/or railroad asset subcomponents that are depicted in the image data. For example, the on-board computing system 102 may use computer vision techniques, for instance via the real-time defect detector 132, to determine whether rails depicted in the image data are shaped or bent in a way that indicates that the rails are buckled. Similarly, the on-board computing system 102 may use computer vision techniques, for instance via the real-time defect detector 132, to determine whether the image data shows damage to other types of railroad assets 106, and/or any subcomponents of those railroad assets 106, identified within the image data.

The on-board computing system 102 may accordingly use the real-time asset analyzer 112 to detect defects in rails, other types of railroad assets 106, and/or individual subcomponents of types of railroad assets 106 that are depicted within image data captured by the camera 108, substantially in real-time when the image data is captured by the camera 108. Accordingly, the on-board computing system 102 may generate defect alert 120 that may alert an operator of the railroad vehicle 104 in real-time, or near real-time, about defects in upcoming or nearby railroad assets 106 that the on-board computing system 102 has detected based on captured image data that depicts those railroad assets 106.

Although the real-time defect detector 132 may use computer vision techniques to evaluate the image data captured by the camera 108 at a particular point in time to detect defects shown in the image data, the real-time defect detector 132 may not be configured to identify defects that are associated with changes to railroad assets 106 over longer periods of time. For instance, if a section of rail has been drifting and changing position over a three-month period of time, but the section of rail is not bent beyond a threshold that the real-time defect detector 132 is configured to identify as the section of rail being buckled, the real-time defect detector 132 may not identify a defect with that section of rail based on new image data depicting the most recent state of the section of rail.

However, as described herein, the on-board computing system 102 may also generate compact asset data 114 representing the state of railroad assets 106, and/or subcomponents of the railroad assets 106, that the real-time asset analyzer 112 identifies based on analysis of image data captured by the camera 108 on the railroad vehicle 104. Such compact asset data 114 associated with a point in time may be compared against other compact asset data 114 associated with other points in time, in order to determine whether states of railroad assets 106 and/or subcomponents of the railroad assets 106 have changed over time. For instance, comparisons of compact asset data 114 associated with multiple times over a period of time may indicate that shapes, orientations, and/or locations of individual railroad assets 106, or individual subcomponents of the railroad assets 106, have changed over time. Such changes over time may be due to defects or other issues with railroad assets 106 or individual subcomponents of the railroad assets 106. Accordingly, while the real-time defect detector 132 may be configured to evaluate image data associated with one point in time, such that the real-time defect detector 132 is not configured to use historical data to detect defects with railroad assets 106, comparisons compact asset data 114 associated with different points in time may allow defects associated with changes to railroad assets 106 over time to be detected.

The compact asset data 114 may represent shapes, orientations, and/or locations of one or more types of railroad assets 106, and/or one or more types of subcomponents of the railroad assets 106, using relatively small amounts of data. As an example, the compact asset data 114 may include rail data 126 that represents shapes and locations of particular sections of rail using vectors or splines and corresponding coordinates. As another example, the compact asset data 114 may include other asset data 128 that represents shapes, orientations, and locations of other types of railroad assets 106, and/or individual subcomponents of those other types of railroad assets 106, using polygons and/or corresponding coordinates of vertices of the polygons.

Accordingly, the compact asset data 114 may represent the shapes, orientations, and/or locations of one or more types of railroad assets 106, and/or one or more types of subcomponents of the railroad assets 106, using less data than would be used to store high resolution images or point-cloud data that could indicate the shapes, orientations, and/or locations of the railroad assets 106 and/or railroad asset subcomponents. Accordingly, the remote computing system 118 may use less memory or digital storage space to store compact asset data 114 associated with multiple geographical areas and/or multiple points in time, relative to storing large libraries of full resolution images and/or point cloud data associated with those multiple geographical areas and/or multiple points in time. Similarly, the on-board computing system 102 on the railroad vehicle 104 may be configured to download and store compact asset data 114 associated with geographical areas along a route that the railroad vehicle 104 will be traveling, such that the compact asset data 114 may be downloaded and stored using less memory and less bandwidth relative to downloading and storing full resolution images and/or point cloud data that represent previous states of railroad assets 106 and/or railroad asset subcomponents present within that geographical area.

While aspects of the present disclosure have been particularly shown and described with reference to the embodiments above, it will be understood by those skilled in the art that various additional embodiments may be contemplated by the modification of the disclosed machines, systems, and method without departing from the spirit and scope of what is disclosed. Such embodiments should be understood to fall within the scope of the present disclosure as determined based upon the claims and any equivalents thereof.

What is claimed is:

1. A method, executed by a computing system comprising a processor, comprising:
obtaining image data captured by a camera on-board a railroad vehicle at a first time;
identifying a railroad asset depicted in the image data;
generating first compact asset data representing a shape and a location of the railroad asset at the first time;
comparing the first compact asset data with second compact asset data that represents the shape and the location of the railroad asset at a second time; and
determining, based on comparing the first compact asset data with the second compact asset data, that at least one of the shape or the location of the railroad asset has changed over a period of time between the first time and the second time.

2. The method of claim 1, further comprising generating a defect alert indicating that the at least one of the shape or the location of the railroad asset has changed over the period of time.

3. The method of claim 1, wherein:
the railroad asset is a section of rail,
generating the first compact asset data comprises determining a vector or a spline, and coordinates, that define the shape and the location of the section of rail at the first time, and
the first compact asset data indicates the vector or the spline and the coordinates.

4. The method of claim 1, wherein:
the railroad asset is an infrastructure element that comprises multiple subcomponents,
the computing system identifies, based on the image data, the multiple subcomponents of the railroad asset,
generating the first compact asset data comprises determining polygons that respectively define at least one of shapes, orientations, or locations of the multiple subcomponents of the railroad asset, and
the first compact asset data indicates the polygons.

5. The method of claim 4, wherein the infrastructure element is a railroad switch, and the multiple subcomponents include two or more of: one or more closure rails, one or more guard rails, or a frog.

6. The method of claim 4, wherein the infrastructure element is a railroad crossing, and the multiple subcomponents include two or more of: one or more crossing rails, or a roadway.

7. The method of claim 4, wherein the infrastructure element is a railroad bridge, and the multiple subcomponents include two or more of one or more bridge rails, a bridge deck, one or more bridge railings, or one or more bridge fences.

8. The method of claim 1, wherein:
the computing system is an on-board computing system of the railroad vehicle, and
the computing system downloads the second compact asset data from a remote computing system.

9. The method of claim 1, wherein:
the computing system is an on-board computing system of the railroad vehicle,
the computing system transmits a compact asset data update, associated with the first compact asset data generated by the on-board computing system, to a remote computing system that maintains a repository of compact asset data, and
the compact asset data update causes the remote computing system to update the repository to include the first compact asset data.

10. The method of claim 1, further comprising determining, by using computer vision operations based on the image data, that the image data depicts a defect with the railroad asset.

11. The method of claim 10, wherein:
the railroad asset is an infrastructure element that comprises multiple subcomponents,
the computing system identifies, based on the image data, the multiple subcomponents of the railroad asset, and
the computer vision operations determine that the defect is associated with one or more of the multiple subcomponents of the railroad asset.

12. The method of claim 1, wherein:
the computing system uses deep learning systems to identify the railroad asset depicted in the image data,
the railroad asset is an infrastructure element that comprises multiple subcomponents, and
the computing system uses the deep learning systems to identify, based on the image data, the multiple subcomponents of the railroad asset.

13. A railroad asset monitoring system, comprising:
a camera, on a railroad vehicle, configured to capture image data depicting an environment that is at least partially in front of the railroad vehicle; and
an on-board computing system, on the railroad vehicle, configured to perform operations comprising:
obtaining the image data captured by the camera at a first time;
identifying a railroad asset depicted in the image data;
generating first compact asset data representing a shape and a location of the railroad asset at the first time;
comparing the first compact asset data with second compact asset data that represents the shape and the location of the railroad asset at a second time; and
determining, based on comparing the first compact asset data with the second compact asset data, that at least one of the shape or the location of the railroad asset has changed over a period of time between the first time and the second time.

14. The railroad asset monitoring system of claim 13, wherein:
the railroad asset is a section of rail,
generating the first compact asset data comprises determining a vector or a spline, and coordinates, that define the shape and the location of the section of rail at the first time, and
the first compact asset data indicates the vector or the spline and the coordinates.

15. The railroad asset monitoring system of claim 13, wherein:
the railroad asset is an infrastructure element that comprises multiple subcomponents,
the on-board computing system identifies, based on the image data, the multiple subcomponents of the railroad asset,
generating the first compact asset data comprises determining polygons that respectively define at least one of shapes, orientations, or locations of the multiple subcomponents of the railroad asset, and
the first compact asset data indicates the polygons.

16. The railroad asset monitoring system of claim 13, wherein the operations further comprise determining, by using computer vision operations based on the image data, that the image data depicts a defect with the railroad asset.

17. A computing system, comprising:
one or more processors; and
memory storing computer-executable instructions that, when executed by the one or more processors, cause the one or more processors to perform operations comprising:
identifying first compact asset data representing a shape and a location of a railroad asset at a first time;
identifying second compact asset data representing the shape and the location of the railroad asset at a second time; and
determining, based on comparing the first compact asset data with the second compact asset data, that at least one of the shape or the location of the railroad asset has changed over a period of time between the first time and the second time,
wherein the first compact asset data and the second compact asset data respectively use at least one of a polygon, a vector, or a spline to define the shape and the location of the railroad asset.

18. The computing system of claim 17, wherein:
the railroad asset is an infrastructure element that comprises multiple subcomponents, and
the first compact asset data and the second compact asset data indicate shapes and locations of one or more of the multiple subcomponents.

19. The computing system of claim 17, wherein the computing system is an on-board computing system of a railroad vehicle that is configured to:
download the first compact asset data from a remote computing system, and
generate the second compact asset data by:
obtaining image data captured by a camera on-board the railroad vehicle;
using image processing operations to identify the railroad asset depicted in the image data; and
determining the at least one of the polygon, the vector, or the spline that defines the shape and the location of the railroad asset depicted in the image data.

20. The computing system of claim 17, wherein the computing system is a remote computing system, separate from a railroad vehicle, that is configured to:
store the first compact asset data in a repository;
receive a compact asset data update, from an on-board computing system of the railroad vehicle, that defines the second compact asset data, wherein the on-board computing system generates the second compact asset data based on image data captured by a camera on the railroad vehicle that depicts the railroad asset; and
update the repository to include the second compact asset data.

21. A method executed by a computing system, comprising a processor, and on-board a railroad vehicle, comprising:
obtaining image data captured by a camera on-board the railroad vehicle;
identifying, by analyzing the image data, a first classification of a railroad asset depicted in the image data, wherein the railroad asset is an infrastructure element that comprises multiple subcomponents;
identifying, by analyzing the image data, a second classification of a subcomponent of the railroad asset; and
determining, by using computer vision operations to evaluate the image data based on the second classification, that the image data depicts a defect with the subcomponent of the railroad asset.

22. The method of claim 21, further comprising generating a defect alert associated with the subcomponent of the railroad asset.

23. The method of claim 21, wherein the computing system uses deep learning systems to identify the first classification and the second classification.

24. The method of claim 21, wherein the infrastructure element is a railroad switch, and the multiple subcomponents include two or more of: one or more closure rails, one or more guard rails, or a frog.

25. The method of claim 21, wherein the infrastructure element is a railroad crossing, and the multiple subcomponents include two or more of: one or more crossing rails, or a roadway.

26. The method of claim 21, wherein the infrastructure element is a railroad bridge, and the multiple subcomponents include two or more of one or more bridge rails, a bridge deck, one or more bridge railings, or one or more bridge fences.
